(19) United States
(12) Patent Application Publication
(10) Pub. No.: US 2005/0243046 A1
(43) Pub. Date: Nov. 3, 2005

(54) Liquid crystal display device

(75) Inventor: Young Gi Hong, Gumi-si (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/118,525

(22) Filed: Apr. 29, 2005

(30) Foreign Application Priority Data
May 3, 2004 (KR) 30925/2004

(51) Int. Cl. G09G 3/36

(52) U.S. Cl. 345/87

(57) ABSTRACT

A liquid crystal display (LCD) includes a liquid crystal panel driven by gate signals from a gate driver, an interface for converting an external video signal into an LVDS (low voltage differential signal), a reset circuit for generating a reset signal for initializing the LCD, a discharge circuit provided between the gate driver and the liquid crystal panel to discharge a residual voltage existing in the liquid crystal panel, and a controller for processing the LVDS converted in the interface and for performing initialization of the LCD in response to the reset signal. A resistor provided at an output terminal of the interface and a resistor for the reset circuit is integrated into the controller, and a resistor for the discharge circuit is integrated into the gate driver as transistors.

### PRIORITY CLAIM

The present application claims the benefit of Korean Application No. 2004-30925 filed on May 3, 2004, which is hereby incorporated by reference.

### FIELD OF THE INVENTION

The present invention relates to a liquid crystal display device, and more particularly, to a liquid crystal display device that is capable of reducing the number of elements and a manufacturing cost by integration of resistors.

### DESCRIPTION OF THE RELATED ART

A liquid crystal display device (LCD) is a representative flat display device that displays an image by controlling transmission of light beams corresponding to video signals. The LCD has a lot of advantages, including being light weight, having a slim profile, low power consumption, and a low voltage driving. Accordingly, the LCD is widely used in various applications.

In order to drive the LCD, a timing controller, a gate driver and a data driver are used. The timing controller, the gate driver and the data driver are integrated based on functions and are mounted on a printed circuit board and the like. Except the timing controller, the gate driver and the data driver, passive elements such as separate resistors and capacitors are provided at peripheral input/output terminals and perform their functions.

For example, as shown in FIG. 1, a resistor R1 is provided at an input terminal of a timing controller 20 so as to match the impedance of a low voltage differential signal (hereinafter, referred to as an LVDS). Also, a reset circuit 15 consisting of resistors R1 and R2 and capacitors C1 and C2 is provided to generate a reset signal for initializing a setup of the LCD. Here, the resistor R1 for the impedance matching is fixed to 100 Ω.

In order to suppress signal noise, the LVDS converts a voltage (about 3.3 V) of a video signal provided from a transmitter side into a low voltage (about 0.3 V or less) and then is provided to the timing controller 20. At this point, it is an LVDS interface 10 that converts the video signal of 3.3 V into the low voltage of 0.3 V or less. Also, in order to stably provide the video signal from the LVDS interface 10 to the timing controller 20, the resistor R1 for the impedance matching is provided at the input terminal of the timing controller 20.

As shown in FIG. 2, in order to discharge a residual voltage on a liquid crystal panel (not shown), a discharge circuit 35 consisting of a resistor Rd and a capacitor Cd is provided at an output terminal of a gate driver 30.

The gate driver 30 generates a gate signal Vg, that is, a gate high signal of 20 V and a gate low voltage of −5 V, and supplies the gate signal to a gate line of the liquid crystal panel (not shown). That is, the gate high signal is supplied to select a specific gate line and otherwise the gate low voltage is supplied. At this point, a predetermined residual voltage exists on the specific gate line. If such a residual voltage is continuously accumulated, a thin film transistor (TFT) of the liquid crystal panel is turned on and an unintended image may be displayed. Accordingly, the discharge circuit 35 shown in FIG. 2 is provided for discharging the residual voltage existing on the gate line.

As described above, the passive elements including the resistors or capacitors provided outside the timing controller 20 or the gate driver 30 are mounted on the printed circuit board in a form of parts by a soldering and the like. However, if the passive elements are mounted outside the timing controller 20 or the gate driver 30 by soldering, the possibility that a defect will occur due to the soldering increases and thus an operation error may be caused. Also, the passive elements that are mounted outside the timing controller 20 or the gate driver 30 occupy a large area. Further, when the passive elements are mounted, the manufacturing cost increases.

### SUMMARY OF THE INVENTION

By way of example only, in one embodiment, an LCD includes an interface for converting an external video signal into an LVDS (low voltage differential signal), and a controller for processing the LVDS converted in the interface. A resistor provided at an output terminal of the interface is integrated into the controller.

In another aspect of the present invention, an LCD includes a reset circuit for generating a reset signal for initializing the LCD, and a controller for performing an initialization of the LCD in response to the reset signal. A resistor of the reset circuit is integrated into the controller.

In another aspect of the present invention, an LCD includes a gate driver for generating a gate signal, a liquid crystal panel configured to be driven depending on the gate signal, and a discharge circuit provided between the gate driver and the liquid crystal panel to discharge a residual voltage existing in the liquid crystal panel. One or more resistors for the discharge circuit is integrated into the gate driver. Each of the above aspects may be combined.

In another aspect of the present invention, a method of fabricating an LCD includes providing a gate driver for generating a gate signal, providing a liquid crystal panel configured to be driven depending on the gate signal, and providing a discharge circuit provided between the gate driver and the liquid crystal panel to discharge a residual voltage existing on the liquid crystal panel. One or more resistors for the discharge circuit is integrated into the liquid crystal panel using a semiconductor manufacturing process.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exemplary view of a related art LCD in which passive elements are mounted outside a timing controller in a form of parts;

FIG. 2 is another exemplary view of a related art LCD in which passive elements are mounted outside a gate driver in a form of part;

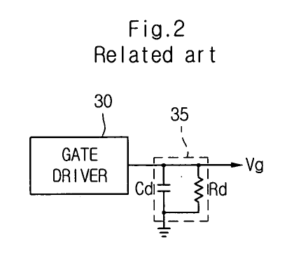

FIG. 3 is a schematic view of an LCD according to an embodiment of the present invention, in which passive elements are integrated in a timing controller; and

FIG. 4 is a schematic view of an LCD according to another embodiment of the present invention, in which passive elements are integrated in a gate driver.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

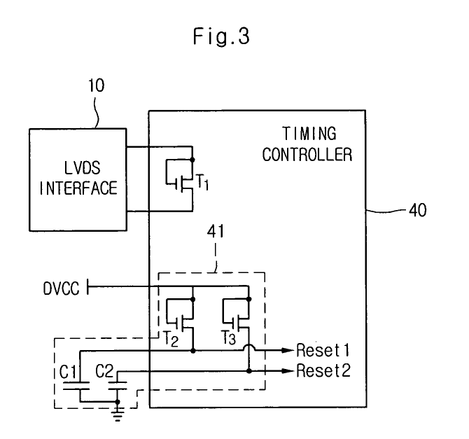

FIG. 3 is a schematic view of an LCD according to an embodiment of the present invention, in which passive elements are integrated in a timing controller. Referring to FIG. 3, an LCD according to an embodiment of the present invention includes an LVDS interface 10 for converting a voltage of a video signal provided from an outside (a transmitter side) into an LVDS of a low voltage, a timing controller 40 connected to the LVDS interface 10, and a reset circuit 41 connected to an input terminal of the timing controller 40 to initial a setup of the LCD.

At this point, a resistor T1 for matching an impedance of the LVDS converted in the LVDS interface 10 is integrated into the timing controller 40. The resistor T1 may be configured with a PMOS transistor or an NMOS transistor.

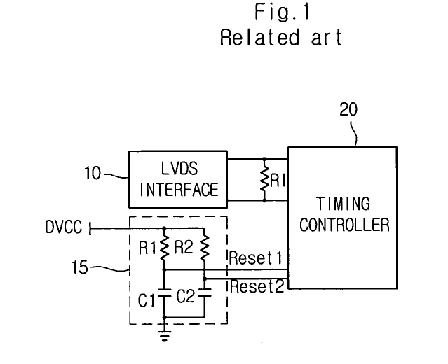

In the related art shown in FIG. 1, the resistor R1 for the impedance matching of the LVDS is provided between the LVDS interface 10 and the timing controller 20. In this case, since the resistor R1 is mounted in a form of a part, the possibility that the defect will occur due to the soldering increases. Also, the manufacturing cost increases and the occupied area increases.

On the contrary, in the embodiment of the present invention, the resistor T1 for the impedance matching of the LVDS is integrated into the timing controller 40, thus reducing the occupied area. Also, a low-cost integration process can decrease the manufacturing cost and the defect caused by the soldering can be prevented.

Meanwhile, the reset circuit 41 includes resistors T2 and T3 and capacitors C1 and C2. While the resistors T2 and T3 are integrated into the timing controller 40, the capacitors C1 and C2 are connected to the resistors T2 and T3 and are mounted outside the timing controller 40. At this point, the resistor T2 is serially connected to the capacitor C1, and the resistor T3 is serially connected to the capacitor C2. Also, a first reset terminal Reset1 is branched between the resistor T2 and the capacitor C1, and a second reset terminal Reset2 is branched between the resistor T3 and the capacitor C2. Accordingly, first and second reset signals can be outputted through the first and second reset terminals Reset1 and Reset2, depending on changes of the resistors T2 and T3 and the capacitors C1 and C2.

In the related art shown in FIG. 1, the capacitors C1 and C2 as well as the resistors R1 and R2 in the reset circuit 15 are mounted outside the timing controller 20 in the form of parts. Accordingly, the entire area increases due to the area occupied by the parts, and the cost for the parts increases. Also, the possibility that the defect will occur due to the soldering increases.

However, in the embodiment of the present invention, the resistors T2 and T3 of the reset circuit 41 are integrated into the timing controller 40. Accordingly, the number of parts is reduced by the number of integrated resistors, thus decreasing the manufacturing cost and the occupied area.

In the reset circuit 41, the capacitors C1 and C2 are not embedded in the timing controller 40. This is because it is difficult to integrate the capacitors C1 and C2 into the timing controller 40. If the capacitors C1 and C2 can be integrated in the future, it is preferable that the capacitors C1 and C2 should also be embedded into the timing controller 40.

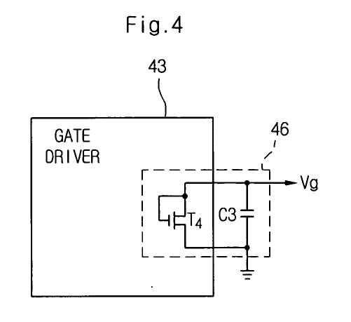

FIG. 4 is a schematic view of an LCD according to another embodiment of the present invention, in which passive elements are integrated in a gate driver.

Referring to FIG. 4, an LCD according to another embodiment of the present invention includes a gate driver 43 for generating a gate signal Vg, and a discharge circuit 46 connected to the gate driver 43 to discharge a residual voltage existing on a gate line of a liquid crystal panel (not shown). Consequently, the discharge circuit 46 is provided between the gate driver 43 and the liquid crystal panel.

In general, the gate signal Vg, that is, a gate high signal (e.g., 20-25 V) or a gate low signal (e.g., −5 V), are periodically supplied to the gate line of the liquid crystal panel. In other words, the gate high signal is applied to activate a specific gate line of the liquid crystal panel and turn on a thin film transistor (TFT). After a predetermined time elapses, the gate low signal is signal to deactivate the specific gate line. Thus, the TFT is turned off. When the TFT is turned on, a specific data signal is applied to a pixel electrode through the TFT, thereby displaying a desired image. As the gate high signal or the gate low signal is periodically applied to the specific line, a residual voltage exists on the specific gate line. If such a residual voltage is continuously accumulated, the TFT is unexpectedly turned on and thus an intended image may be displayed. In order to remove the residual voltage existing on the gate line, the discharge circuit 46 is provided between the gate driver 43 and the liquid crystal panel.

In the discharge circuit 46, a capacitor C3 for charging the gate signal Vg is mounted outside the gate driver 43 in a form of a part. This is because the integration of the capacitor is difficult. However, if the capacitor can be easily integrated in the future, it is apparent that the capacitor C3 of the discharge circuit 46 can be embedded into the gate driver 43.

By embedding the resistor T4 of the discharge circuit 46 into the gate driver 43 can prevent the possibility of a defect due to the soldering. Also, the integration can reduce the manufacturing cost and the occupied area.

Although the embodiment shown in FIG. 4 illustrates that the resistor T4 of the discharge circuit is embedded into the gate driver 43, the resistor T4 can also be embedded in the liquid crystal panel. The liquid crystal panel includes a lower substrate having TFTs arranged in a matrix form, an upper substrate having color filters, and a liquid crystal layer interposed between the two substrates. At this point, in addition to the TFTs, gate lines, data lines and pixel electrodes are manufactured on the lower substrate using a semiconductor manufacturing process. Accordingly, the resistor T4 provided in the discharge circuit 46 can be embedded in the lower substrate using the semiconductor manufacturing process. In this case, the capacitor C3 is also mounted on the printed circuit board in a form of a part.

As described above, the integration of the resistor can decrease the defective caused by the soldering. Also, the integration of the parts can greatly reduce the manufacturing cost and increase the area efficiency, contributing to the light weight and slim profile.

It will be apparent to those skilled in the art that various modifications and variations can be made in the present invention. Thus, it is intended that the present invention covers the modifications and variations of this invention provided they come within the scope of the appended claims and their equivalents.

1. A liquid crystal display (LCD) comprising:
an interface for converting an external video signal into an LVDS (low voltage differential signal); and
a controller for processing the LVDS converted in the interface,
wherein a resistor that is provided at an output terminal of the interface and that matches an impedance of the LVDS is integrated in the controller.

2. The LCD according to claim 1, wherein the resistor is a three terminal device.

3. The LCD according to claim 2, wherein the resistance of the resistor varies as a function of a voltage supplied to the resistor.

4. The LCD according to claim 1, wherein the resistor is configured with one of a PMOS transistor and an NMOS transistor.

5. A liquid crystal display (LCD) comprising:
a reset circuit for generating a reset signal for initializing the LCD; and
a controller for performing an initialization of the LCD in response to the reset signal,
wherein a resistor of the reset circuit is integrated into the controller, and the resistor matches an impedance of a signal supplied to the controller.

6. The LCD according to claim 5, wherein the resistor is a three terminal device.

7. The LCD according to claim 6, wherein a resistance of the resistor varies as a function of a voltage supplied to the resistor.

8. The LCD according to claim 5, wherein the resistor is configured with one of a PMOS transistor and an NMOS transistor.

9. The LCD according to claim 5, wherein the reset circuit contains multiple resistors that are integrated into the controller.

10. The LCD according to claim 5, further comprising an interface for converting an external video signal into an LVDS (low voltage differential signal), wherein the controller processes the LVDS converted in the interface and a resistor that is provided at an output terminal of the interface and that matches an impedance of the LVDS is integrated in the controller.

11. The LCD according to claim 5, further comprising a gate driver for generating a gate signal, a liquid crystal panel configured to be driven depending on the gate signal, and a discharge circuit provided between the gate driver and the liquid crystal panel to discharge a residual voltage existing in the liquid crystal panel, wherein a resistor of the discharge circuit is integrated into the gate driver.

12. The LCD according to claim 10, further comprising a gate driver for generating a gate signal, a liquid crystal panel configured to be driven depending on the gate signal, and a discharge circuit provided between the gate driver and the liquid crystal panel to discharge a residual voltage existing in the liquid crystal panel, wherein a resistor of the discharge circuit is integrated into the gate driver.

13. A liquid crystal display (LCD) comprising:
a gate driver for generating a gate signal;
a liquid crystal panel configured to be driven depending on the gate signal; and
a discharge circuit provided between the gate driver and the liquid crystal panel to discharge a residual voltage existing in the liquid crystal panel,
wherein a resistor of the discharge circuit is integrated into the gate driver.

14. The LCD according to claim 13, wherein the resistor is a three terminal device.

15. The LCD according to claim 14, wherein a resistance of the resistor varies as a function of a voltage supplied to the resistor.

16. The LCD according to claim 13, wherein the resistor is configured with one of a PMOS transistor and an NMOS transistor.

17. A method of fabricating a liquid crystal display, the method comprising:
providing a gate driver for generating a gate signal;
providing a liquid crystal panel configured to be driven depending on the gate signal;
providing a discharge circuit provided between the gate driver and the liquid crystal panel to discharge a residual voltage existing on the liquid crystal panel, a resistor of the discharge circuit being integrated into the liquid crystal panel using a semiconductor manufacturing process.

18. The method according to claim 17, wherein the resistor is a three terminal device.

19. The method according to claim 18, wherein a resistance of the resistor varies as a function of a voltage supplied to the resistor.

20. The method according to claim 17, wherein the resistor is configured with one of a PMOS transistor and an NMOS transistor.

21. A liquid crystal display (LCD) comprising:
a gate driver for generating a gate signal;
a liquid crystal panel configured to be driven depending on the gate signal;
an interface for converting an external video signal into an LVDS (low voltage differential signal);
a reset circuit for generating a reset signal for initializing the LCD;
a controller for processing the LVDS converted in the interface, the controller containing a resistor of the reset circuit that generates the reset signal and a resistor that matches an impedance of a LVDS signal supplied to the controller integrated therein; and
a discharge circuit provided between the gate driver and the liquid crystal panel to discharge a residual voltage existing in the liquid crystal panel, the gate driver containing multiple resistors of the discharge circuit integrated therein.

22. The LCD according to claim 21, wherein the reset circuit and the discharge circuit contain capacitors that are not integrated in the controller and the gate driver, respectively.

23. The LCD according to claim 21, wherein each of the integrated resistors is implemented using a transistor.
